(19) United States
(12) Patent Application Publication
(10) Pub. No.: US 2025/0236201 A1
(43) Pub. Date: Jul. 24, 2025

(54) HANDLING ERRORS IN AN ELECTRIC VEHICLE CHARGING SESSION

(71) Applicant: Quanta Technology, LLC, Raleigh, NC (US)

(72) Inventors: Nikoo Kouchakipour, East Gwillimbury (CA); Joshua Piruzza, Toronto (CA); Vickkram Ramarethinam, Toronto (CA); Ishmam Abiaz Zaman, Chicago, IL (US)

(21) Appl. No.: 19/030,305

(22) Filed: Jan. 17, 2025

Related U.S. Application Data
(60) Provisional application No. 63/623,219, filed on Jan. 20, 2024.

(51) Int. Cl. B60L 53/66

(52) U.S. Cl. CPC B60L 53/66

(57) ABSTRACT

Controller equipment for an electric vehicle (EV) comprises an EV communication controller (EVCC) configured with programmable logic that controls communication between the EV and an electric vehicle supply equipment (EVSE). The controller equipment performs a diagnostic process to (i) diagnose a charging session error as being caused by non-conformance of communication between the EV and the EVSE to a governing standard; and (ii) determine a criticality of and/or a suggested fix for the non-conformance. The results of the diagnostic process may be provided to a user or control unit, so that the user or control unit can provide the controller equipment with instructions on how to handle the non-conformance. The controller equipment then dynamically adapts the programmable logic of the EVCC to handle the non-conformance, e.g., according to instructions received from the user or control unit.

### RELATED APPLICATIONS

This application claims the benefit of U.S. Provisional Application No. 63/623,219, filed Jan. 20, 2024, the entire contents of which is incorporated by reference herein.

### TECHNICAL FIELD

The present application relates generally to electric vehicle (EV) charging, and relates more specifically to handling of errors in an EV charging session.

### BACKGROUND

Electric vehicles (EVs) are vehicles powered by electricity stored in rechargeable batteries instead of or in addition to traditional internal combustion engines. EVs in this regard include battery electric vehicles (BEVs) and plug-in hybrid electric vehicles (PHEVs). They offer numerous benefits, including reduced greenhouse gas emissions, lower operating costs, and quieter operation. To recharge their batteries, EVs rely on Electric Vehicle Supply Equipment (EVSE), commonly referred to as charging stations. EVSE provides the necessary electrical connection and power supply, ranging from slow home chargers to high-power public fast chargers. EVSEs may provide power transfer to an EV via conductive power transfer or via wireless power transfer. For conductive power transfer, for instance, an EVSE may include conductors, EV couplers, attached plugs, and other accessories, devices, power outlets, or apparatuses installed specifically for the purpose of delivering energy from premises wiring to the EV and allowing communication between them as necessary. EVSE helps ensure the usability and convenience of EVs for everyday commuting and long-distance travel.

Towards this end, an EV includes embedded therein an Electric Vehicle Communication Controller (EVCC). The EVCC controls communication between the EV and the EVSE, managing operations such as authentication, charging control, and data exchange. On the other side, the EVSE includes embedded therein a Supply Equipment Communication Controller (SECC) that coordinates the charging process by interacting with the EVCC to negotiate charging parameters, ensure power delivery, and monitor safety protocols.

There are standards to govern the communication exchanged between the EV and the EVSE via the EVCC and SECC in a standardized way. DIN SPEC 70212 and International Organization for Standardization (ISO) 15118 are two such standards that govern implementation of the charging sequence.

The ISO 15118 standard is also known as “Road vehicles—Vehicle to grid communication interface”. According to ISO 15118, a charging session begins when the EV is physically connected to the EVSE through a compatible charging cable or wirelessly paired with the EVSE. Initial low-level signaling occurs through the Control Pilot (CP) signal, as specified by IEC 61851-1, to confirm the connection. Once the connection is established, the EV and EVSE initiate high-level communication using Internet Protocol (IP)-based protocols over a Power Line Communication (PLC) channel, utilizing the HomePlug Green PHY standard. Next, the EV and EVSE negotiate the charging parameters. The EV communicates its battery state of charge (SoC), energy needs, and desired charging duration, while the EVSE declares its capabilities, including available power, charging limits, and grid constraints. Once agreed, the EVSE begins supplying energy to the EV while both parties exchange real-time data to monitor power delivery, ensure safety, and adjust charging rates dynamically as needed. Information such as charging progress, cost, and estimated completion time is typically displayed to the user via the EV or EVSE interface. The charging session ends either automatically when the battery reaches the desired charge or manually by the user. A final settlement message is exchanged to finalize billing for Plug & Charge scenarios. After confirming the termination with the EVSE, the user can safely unplug the vehicle.

Both ISO 15118 and DIN SPEC 70212 leverage an Open Systems Interconnection (OSI) model to achieve this communication for completing a charging sequence. FIG. 1 shows one such model for defining the communication sent between the EV charger and the EV according to the ISO 15118 standard.

At the Physical Layer, the standard uses Power Line Communication (PLC) as the medium for data exchange; namely, Home Plug Green PHY Power Line Communication (PLC). This means that communication sent between the charger and EV is sent via PLC, or high frequency alternating current (AC) signals communicated over a direct current (DC) line (in this case communication is sent through AC signals over the DC Control Pilot Line). The Data Link Layer ensures stable and error-free communication over the PLC network. Moving to the Network Layer, the standard relies on Internet Protocol (IP) for addressing and routing, enabling communication across diverse network infrastructures. At the Transport Layer, the stack incorporates Transmission Control Protocol (TCP) for reliable data transmission and Transport Layer Security (TLS) to provide encrypted and secure communication, protecting sensitive data such as ‘payment information. The Session Layer is defined by the Vehicle-to-Grid (V2G) session protocol, which establishes and manages the interactions between the EV and the charging station throughout the charging session. The Presentation Layer employs extensible Markup Language (XML)-based data formats to structure and encode messages, ensuring both devices interpret the data consistently. Finally, at the Application Layer, ISO 15118 enables advanced features such as Plug & Charge authentication, energy transfer scheduling, and payment authorization. Thus, according to the model in FIG. 1, an EVCC will communicate to an SECC by generating an XML communication and then encoding that XML communication into PLC messages that can be sent to the SECC.

Standards governing communication between an EV and EVSE target interoperability to ensure that EVs and EVSEs from different manufacturers can communicate seamlessly and perform all charging-related functions without compatibility issues. Interoperability for example means that an EV from one manufacturer can charge at any ISO 15118-compliant station, regardless of the EVSE brand or the backend system supporting it. Standards achieve this by defining common data structures, messaging formats, and communication processes that all participants in the charging ecosystem must adhere to. As a result, EV owners benefit from a consistent and reliable charging experience, while manufacturers and service providers can reduce costs by avoiding custom integrations. Standards also support the scalability of EV infrastructure, allowing manufacturers, utility providers, and network operators to build systems that are future-proof and adaptable to evolving technologies.

Challenges exist with realizing this ideal in practice, though. Indeed, in real-world implementations, interoperability issues may arise between an EV and EVSE even if both EV and EVSE claim to comply with the same standard for communication between them. Addressing these interoperability issues heretofore requires access to specialized testing equipment and highly trained technicians.

### SUMMARY

Some embodiments herein include controller equipment for an electric vehicle (EV) that enables the EV to self-diagnose and/or fix some types of charging session errors that are caused by an EV supply equipment (EVSE) not complying with communication standards. According to some embodiments, for example, the controller equipment may enable the EV to self-diagnose a charging session error as being caused by communication from an EVSE not complying with a governing standard, e.g., to which the EVSE claims to comply. The controller equipment may furthermore enable the EV itself to identify how critical this non-compliance is to the charging session and/or to identify how to fix the non-compliance, e.g., to prevent the error from occurring in a subsequent charging session. Some embodiments in this regard notably make the EV's communication controller (EVCC) dynamically programmable in terms of the logic that it applies, so that the EVCC's logic can be dynamically adapted (e.g., in the field), as needed to implement any fix identified for a charging session error caused by communication standards non-compliance. Some embodiments may thereby advantageously resolve interoperability issues in the field when those issues arise due to communication standards non-compliance. Some embodiments may even equip an EV to largely resolve these issues itself, so as to avoid the inefficiencies and expense that would otherwise be incurred by involvement of specialized testing equipment and highly trained technicians.

The controller equipment according to some embodiments may nonetheless operate under the ultimate direction or approval of a user or control unit, e.g., a main control unit of the EV. In such cases, though, the controller equipment may equip the user or control unit with the information needed for making an informed decision, e.g., so that the user or control unit need not be specialized or highly trained. For example, in some embodiments, the controller equipment may indicate to the user or control unit that communication standards non-conformance is the cause of a charging session error and indicate the criticality of and/or the suggested fix for the non-conformance. This way, the user or control unit may more intelligently instruct the controller equipment how to handle the non-conformance, without having the specialization or training that would otherwise have been required without some indication of the criticality of and/or fix for the error. Under this guided instruction of the user or control unit, then, the controller equipment may proceed to dynamically adapt its EVCC's programmable logic to handle the error.

Other embodiments herein similarly equip an EVSE tester with the features above, e.g., so as to reduce the specialization and/or training needed to test and troubleshoot EVSEs for interoperability.

More particularly, embodiments herein include controller equipment for an electric vehicle (EV). The controller equipment comprises an electric vehicle communication controller (EVCC) configured with programmable logic that controls communication between the EV and an electric vehicle supply equipment (EVSE). The controller equipment also comprises a communication interface to a user or to a control unit. The controller equipment also comprises processing circuity communicatively coupled to the EVCC and to the communication interface. The processing circuitry is configured to detect an error in a charging session during which the EVSE charges the EV. The processing circuitry is also configured to perform a diagnostic process to (i) diagnose the error as being caused by non-conformance of communication between the EV and the EVSE to a standard that governs the communication; and (ii) determine a criticality of and/or a suggested fix for the non-conformance. The processing circuitry is also configured to provide results of the diagnostic process to the user or the control unit via the communication interface. In some embodiments, the results indicate the non-conformance as a cause of the error and indicate the criticality of and/or the suggested fix for the non-conformance. The processing circuitry is also configured to prompt the user or control unit, via the communication interface, for instructions on how to handle the non-conformance in view of the results of the diagnostic process. The processing circuitry is also configured to dynamically adapt the programmable logic of the EVCC to handle the non-conformance according to the instructions received from the user or the control unit via the communication interface.

Other embodiments herein include EVSE testing equipment for testing an electric vehicle supply equipment (EVSE). The EVSE testing equipment comprises an electric vehicle communication controller (EVCC) configured with programmable logic that controls communication between an emulated electric vehicle (EV) and the EVSE. The EVSE testing equipment also comprises a communication interface to a user or a control unit. The EVSE testing equipment also comprises processing circuity communicatively coupled to the EVCC and to the communication interface. In some embodiments, the processing circuitry is configured to detect an error in an emulated charging session between the EVSE and the emulated EV. In some embodiments, the processing circuitry is configured to perform a diagnostic process to (i) diagnose the error as being caused by non-conformance of communication between the emulated EV and the EVSE to a standard that governs the communication; and (ii) determine a criticality of and/or a suggested fix for the non-conformance. In some embodiments, the processing circuitry is configured to provide results of the diagnostic process to the user or the control unit via the communication interface. In some embodiments, the results indicate the non-conformance as a cause of the error and indicate the criticality of and/or the suggested fix for the non-conformance. In some embodiments, the processing circuitry is configured to prompt the user or the control unit, via the communication interface, for instructions on how to handle the non-conformance in view of the results of the diagnostic process. In some embodiments, the processing circuitry is configured to dynamically adapt the programmable logic of the EVCC to handle the non-conformance according to the instructions received from the user or the control unit via the communication interface.

Other embodiments herein include a method performed by controller equipment for an electric vehicle (EV). The method comprises detecting, by the controller equipment, an error in a charging session during which an electric vehicle supply equipment (EVSE) charges the EV. The method also comprises performing, by the controller equipment, a diagnostic process to (i) diagnose the error as being caused by non-conformance of communication between the EV and the EVSE to a standard that governs the communication; and (ii) determine a criticality of and/or a suggested fix for the non-conformance. The method also comprises providing results of the diagnostic process from the controller equipment to a user or control unit via a communication interface of the controller equipment. In some embodiments, the results indicate the non-conformance as a cause of the error and indicate the criticality of and/or the suggested fix for the non-conformance. The method also comprises prompting the user or the control unit via the communication interface, for instructions to the controller equipment on how to handle the non-conformance in view of the results of the diagnostic process. The method also comprises dynamically adapting, by the controller equipment, programmable logic of an electric vehicle communication controller (EVCC) that controls communication between the EV and the EVSE. In some embodiments, the programmable logic is adapted to handle the non-conformance according to the instructions received from the user or control unit via the communication interface.

Other embodiments herein include a method performed by EVSE testing equipment for testing an electric vehicle supply equipment (EVSE). The method comprises detecting, by the EVSE testing equipment, an error in an emulated charging session during which the EVSE charges an emulated electric vehicle (EV). The method also comprises performing, by the EVSE testing equipment, a diagnostic process to (i) diagnose the error as being caused by non-conformance of communication between the emulated EV and the EVSE to a standard that governs the communication; and (ii) determine a criticality of and/or a suggested fix for the non-conformance. The method also comprises providing results of the diagnostic process from the EVSE testing equipment to a user or a control unit via a communication interface of the EVSE testing equipment. In some embodiments, the results indicate the non-conformance as a cause of the error and indicate the criticality of and/or the suggested fix for the non-conformance. The method also comprises prompting the user or control unit, via the communication interface, for instructions to the EVSE testing equipment on how to handle the non-conformance in view of the results of the diagnostic process. The method also comprises dynamically adapting, by the EVSE testing equipment, programmable logic of an electric vehicle communication controller (EVCC) that controls communication between the EV and the EVSE. In some embodiments, the programmable logic is adapted to handle the non-conformance according to the instructions received from the user or the control unit via the communication interface.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a protocol stack of the ISO 15118 standard according to some embodiments.

FIG. 2 is a block diagram of controller equipment of an electric vehicle (EV) for controlling a charging session with an EV supply equipment (EVSE) according to some embodiments.

FIG. 3 is a call flow diagram showing how programmable logic of the EVCC may be adapted to handle non-conformance in a subsequence charging session according to some embodiments.

FIG. 4 is a block diagram of controller equipment of EVSE tester for controlling an emulated charging session with an EVSE as part of testing the EVSE according to some embodiments.

FIG. 5 is a block diagram of the controller equipment implemented as an IDEAL controller according to some embodiments.

FIG. 6 is a block diagram of a message from an EVSE with an incorrect value for the “unit” parameter.

FIG. 7 is a block diagram of a message from an EVSE with an incorrect value for the “Pmax” parameter.

FIG. 8 is a logic flow diagram of a method performed by controller equipment of an EV according to some embodiments.

FIG. 9 is a logic flow diagram of a method performed by controller equipment of EVSE testing equipment according to some embodiments.

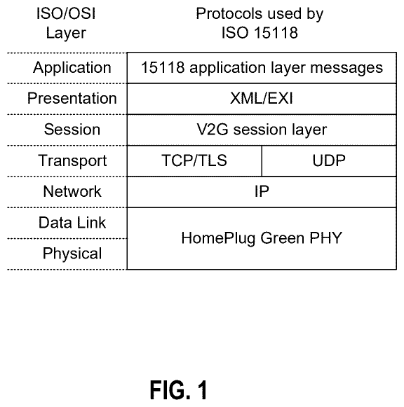

### DETAILED DESCRIPTION

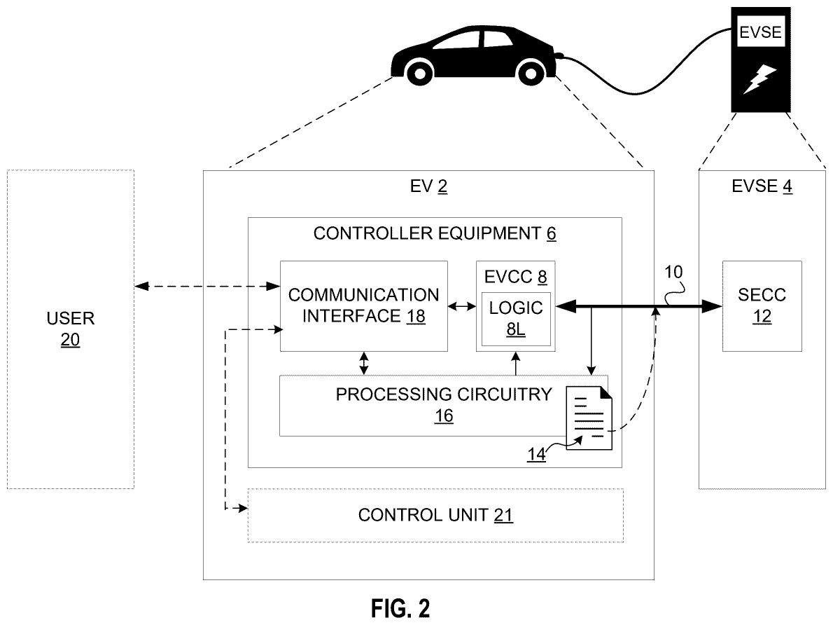

FIG. 2 shows an electric vehicle (EV) 2 according to some embodiments. The EV 2 is powered by electricity stored in one or more rechargeable batteries housed in the EV 2, instead of or in addition to a traditional internal combustion engine. The EV 2 in this regard may be a battery electric vehicle (BEV) or a plug-in hybrid electric vehicle (PHEV).

The EV 2 is configured to be charged by Electric Vehicle Supply Equipment (EVSE) 4, also referred to as a charging station 4. The EVSE 4 is correspondingly configured to provide power transfer to the EV 2 via conductive power transfer or via wireless power transfer. For conductive power transfer, for instance, the EVSE 4 may include conductors, EV couplers, attached plugs, and other accessories, devices, power outlets, or apparatuses installed specifically for the purpose of delivering energy from premises wiring to the EV 2.

Charging of the EV 2 by the EVSE 4 occurs in the context of a charging session. A charging session may refer to a specific period during which the EV 2 is connected to the EVSE 4 to recharge its battery. A charging session may begin when the EV 2 starts drawing electricity from the EVSE 4 and end when the connection with the EVSE 4 is terminated, e.g., either by unplugging the EV 2 from the EVSE 4 for conductive power transfer or when the battery reaches the desired charge level. In some embodiments, a charging session may alternatively or additionally refer to a collection of charging transactions related to the charging of the EV 2 in a specific timeframe.

To control the charging of the EV 2 during a charging session, the EV 2, as shown, has embedded therein controller equipment 6. The controller equipment 6 includes an electric vehicle communication controller (EVCC) 8. The EVCC 8 controls communication 10 between the EV 2 and the EVSE 4. This communication 10 may involve communication of one or more messages and/or communication at one or more layers of a protocol stack such as at an application layer. As an example, the EVCC 8 may manage communication 10 in this regard for the purpose of authenticating the EV 2 to the EVSE 4, authenticating the EVSE 4 to the EV 2, negotiating charging parameters, ensuring power delivery, monitoring safety protocols, etc. From the EVSE side, this communication 10 may correspondingly be controlled by Supply Equipment Communication Controller (SECC) 12 at the EVSE 4. With communication between the EV 2 and EVSE 4 controlled respectively by the EVCC 8 and SECC 12, communication generally referred to as being between the EV 2 and EVSE 4 may in some embodiments more specifically refer to communication between the EVCC 8 and SECC 12.

Regardless, according to embodiments herein, the communication 10 between the EV 2 and the EVSE 4 is governed by a standard 14. This standard 14 may for instance establish a format, timing, sequencing, information content, and/or other aspects of the communication 10, e.g., at one or more layers of a protocol stack. The standard 14 in some embodiments, for example, may define messages, a data model, a message representation format, usage of one or more lower-layer protocols such as TLS or TCP, service sequences of conductive charging and/or power transfer, and/or how data link layer services can be accessed from an OSI layer 3 perspective. As one example, the standard 14 may be the ISO 15118 standard. As another example, the standard 14 may be the DIN SPEC 70212 standard.

In some embodiments, the EV 2 and the EVSE 4 both intend to conform their communication 10 to this same standard 14, i.e., in the sense that they are both nominally programmed or configured with the goal that their communication 10 comply with that standard 14. However, under some circumstances or scenarios, the communication 10 may fail to in fact conform to the standard 14, e.g., due to differences in implementation of the standards, customization or human error in the programming or configuration of the EV 2 and/or EVSE 4. This non-conformance of the communication 10 to the standard 14 threatens to cause an error in a charging session between the EV 2 and the EVSE 4. But, because an error in a charging session may arise for any number of reasons, not just failure of communication 10 to conform to standard 14, it has heretofore proved challenging to adequately address such an error, especially without specialized testing equipment and highly trained technicians. An unaddressed error may heretofore prove fatal to any charging session so as to jeopardize the interoperability of the EV 2 with the EVSE 4.

Notably, embodiments herein equip the EV 2 with controller equipment 6 that has processing circuitry 16 configured to itself perform a diagnostic process for diagnosing a charging session error as being caused by non-conformance of the communication 10 between the EV 2 and the EVSE 14 to the standard 14 governing that communication 10. Rather than requiring specialized testing equipment and highly trained technicians to perform such diagnoses, then, the EV 2 itself is capable of performing self-diagnostics suitable for identifying communication standards non-conformance as being the underlying cause of charging session errors. The processing circuitry 16 in this regard may be configured to transparently intercept or otherwise ‘sniff’ the communication 10 between the EV 8 and the EVSE 4, and compare the communication 10 against the standard 14, e.g., so as to effectively monitor the communication 10 for compliance with the standard 14. The processing circuitry 16 in some embodiments may evaluate the communication 10 for compliance in this way in response to a charging session error occurring, e.g., in a post-mortem review or investigation of why the error has occurred. In other embodiments, though, the processing circuitry 16 may evaluate the communication 10 for compliance proactively during the course of a charging session, e.g., as part of an ongoing review that would help explain the cause of a future error. Either way, the processing circuitry 16 is able to detect non-compliance of the communication 10 with the standard 14 and identify such non-compliance as the culprit for a charging session error, as distinguished from other possible causes.

For example, in some embodiments, the communication 10 includes communication of message(s) between the EV 4 and EVSE 4, e.g., at an application layer. The standard 14 in this case may dictate what parameter(s) each type of message must have or is allowed to have. Alternatively or additionally, for each type of message, the standard 14 may dictate what possible value(s) each parameter in the message is allowed to have. In this latter case, the processing circuitry 16 may be configured to intercept a message (e.g., received from the EVSE 4) and detect that the value of a parameter in the intercepted message does not conform to the standard 14, e.g., that the value to which the parameter is set in the message is not one of the value(s) the parameter is allowed to have according to the standard 14. The processing circuitry 16 may then identify this non-conformance as being a cause of a charging session error, e.g., on the basis of a mapping that maps different possible non-conformances to different possible types of charging session errors.

Embodiments herein furthermore notably equip the EVCC 8 with logic 8L that is programmable, so that the logic 8L is capable of being dynamically adapted (e.g., in the field) to handle non-conformance of communication 10 to the standard 14. The programmable logic 8L may be realized for instance with hardware and/or software (e.g., code) that is programmable to adapt the logic with which the communication 10 is processed.

The processing circuitry 16 may for example dynamically adapt the programmable logic 8L as needed to fix some types of detected non-conformance, e.g., for a current or future charging session. Consider for example a case where the processing circuitry 16 diagnoses a charging session error as being caused by the EV 2 receiving a certain type of message from the EVSE 4 with an incorrect value for a parameter in the message, e.g., a parameter that indicates the units of a voltage value. The value for this parameter may be incorrect in the sense that it is not one of the value(s) that the standard 14 allows the parameter to have. In this case, the processing circuitry 16 may determine that the fix for the detected error is to change the parameter's value to one of the value(s) the parameter is allowed to have according to the standard 14, e.g., a value of “volts”. The processing circuitry 16 may then adapt the programmable logic 8L to implement that fix in one or more subsequent charging sessions. The programmable logic 8L may for example be adapted so that, when the EV 2 receives the message of the certain type from the EVSE 4 in a subsequent charging session, the EVCC 8 will autonomously change or override the value of the parameter in the message to have one of the value(s) the parameter is allowed to have according to the standard 14. Programmed to handle the message in this way for the subsequent charging session, the EVCC 8 will prevent the error from reoccurring in the subsequent charging session, even though the message received from the EVSE 4 did not conform to the standard 14 and would have otherwise caused an error in the subsequent charging session.

Alternatively or additionally, the processing circuitry 16 may be configured to dynamically adapt the programmable logic 8L to consider certain types of errors and/or certain types of non-conformances as non-critical. For example, the programmable logic 8L may be adapted from considering certain types of errors and/or certain types of non-conformances as critical to instead considering those types of errors and/or non-conformances as non-critical. Rather than the errors and/or non-conformances causing charging session termination, then, they may instead only trigger an alarm or warning while letting charging sessions continue.

In still other embodiments, the processing circuitry 16 may be configured to dynamically adapt the programmable logic 8L to simply ignore certain types of errors and/or certain types of non-conformances, e.g., those that are not critical to the charging session. For example, the processing circuitry 16 may be configured to categorize types of errors and/or types of non-conformances in terms of how critical they are to the charging session. The processing circuitry 16 may correspondingly adapt the programmable logical 8L to ignore a certain type of error and/or non-conformance, if that error or non-conformance has a criticality level below a threshold, e.g., so as to be deemed not critical. For example, if a parameter's value causes an error in a charging session but the error is non-fatal to the session and the parameter's value is not critical, the processing circuitry 16 may adapt the programmable logic 8L so that the EVCC 8 ignores the non-conformance in a subsequent charging session. Rather than the non-conformance stopping the charging session, then, the EVCC 8 may allow the charging session to proceed despite the error and despite the non-conformance. In one or more such embodiments, the processing circuitry 16 may simply produce a warning (e.g., in a log) about the non-conformance.

In these and other embodiments, then, the programmable nature of the EVCC's logic 8L may advantageously enable the EVCC 8 to adapt as needed to operate with an EVSE 4, even when the EV 2 and/or EVSE 4 fail to comply with the same targeted communication standard 14. The controller equipment 6 may thereby advantageously enable the EV 2 to resolve interoperability issues with the EVSE 4, at least when those issues arise due to communication standards non-compliance. Moreover, some embodiments enable the resolution of interoperability issues even in the field, i.e., while deployed and/or in use, without having to take the EV 2 and/or EVSE 4 offline and/or out-of-service for troubleshooting by highly trained technicians with specialized testing equipment. Some embodiments may thus avoid the inefficiencies and expense that would otherwise be incurred by the involvement of specialized testing equipment and highly trained technicians.

Some embodiments may nonetheless operate under the ultimate direction or approval of a user 20 or control unit 21. The user 20 of the controller equipment 6 may be a technician or even a manufacturer of the EV 2. The control unit 21 may be a main control unit 21 of the EV 2 and/or otherwise be a supervisory controller for supervising operation of at least the controller equipment 6. To assist the user 20 or control unit 21, the controller equipment 6 may equip the user 20 or control unit 21 with information needed for making an informed decision, e.g., so that the user 20 or control unit 21 need not be specialized or highly trained.

FIG. 2 for example shows that, in some embodiments, the controller equipment 6 includes a communication interface 18 to the user 20 or the control unit 21. In embodiments where the communication interface 18 is to a user 20, the communication interface 18 may be a human machine interface (HMI). In embodiments where the communication interface 18 is to a control unit 21, the communication interface 18 may be a Controller Area Network (CAN) bus, as one example. Regardless, the processing circuitry 16 exploits this communication interface 18 to provide results of its diagnostic process to the user 20 or control unit 21. The results may for example indicate the non-conformance of the communication 10 to the standard 14 as a cause of an error in a charging session. Alternatively or additionally, the results may indicate a criticality of and/or a suggested fix for the non-conformance. After or in conjunction with providing the results of the diagnostic process to the user 20 or control unit 21, the processing circuitry 16 prompts the user 20 or control unit 21, via the communication interface 18, for instructions on how to handle the non-conformance of the communication 10 to the standard 14. The user 20 or control unit 21 may thereby provide such instructions in view of the results of the diagnostic process, e.g., in view of the criticality of and/or the suggested fix for the non-conformance. Where the user 20 is the manufacturer of the EV 2, for example, the instructions may be embodied as a software update.

The processing circuitry 16 may then dynamically adapt the programmable logic 8L of the EVCC 8 to handle the non-conformance according to the instructions received from the user 20 or control unit 21 via the communication interface 18. For example, where the results of the diagnostic process indicate a suggested fix for the non-conformance, the user 20 or control unit 21 may instruct the controller equipment 6 to handle the non-conformance by implementing the suggested fix. Correspondingly, the processing circuitry 16 may dynamically adapt the programmable logic 8L of the EVCC 8 to implement the suggested fix according to the instructions. Or, at least in cases where the results of the diagnostic process indicate the non-conformance is not critical to a charging session, the user 20 or control unit 21 may instruct the controller equipment 6 to ignore the non-conformance. Correspondingly, the processing circuitry 16 may dynamically adapt the programmable logic 8L of the EVCC 8 to ignore the non--conformance in a subsequent charging session and/or produce a warning about the non-conformance but proceed with the subsequent charging session despite the non-conformance. Thus, rather than considering the non-conformance as being a critical error and terminating the subsequent charging session, the programmable logic 8L as adapted lets the charging session continue on the basis that non-conformance is non-critical.

In some embodiments, the controller equipment 6 may prompt the user 20 or control unit 21 to specify whether its instructions are to be applied temporarily (for a limited number of subsequent charging sessions) or permanently (for all subsequent charging sessions). Whether the user or control unit's instructions are to be applied temporarily or permanently may depend on the nature of the error and/or non-conformance. For example, if the error and/or non-conformance are not critical to a charging session, such as when incorrect units are used in a message, the user 20 or control unit 21 may indicate that its instructions are to be applied permanently for all subsequent charging sessions, e.g., to always ignore and/or proceed past the error and/or non-conformance. By contrast in another example, if the error and/or non-conformance is critical to a charging session, such as when a message announces a negative max power value for charging, the user 20 or control unit 21 may indicate that its instructions are to be applied only temporarily for a limited number (e.g., one) of subsequent charging sessions.

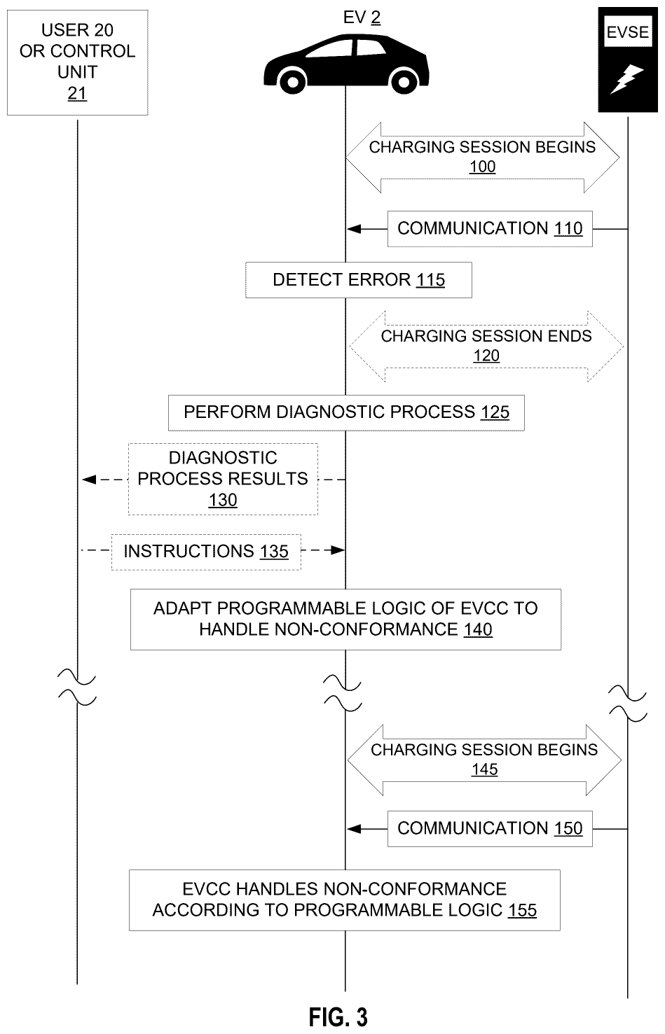

FIG. 3 shows how the programmable logic 8L of the EVCC 8 may be adapted to handle non-conformance in a subsequence charging session according to some embodiments. As shown, the EV 2 and EVSE 4 begin a charging session (Step 100). During this charging session, the EVSE 4 sends communication 110 to the EV 2, e.g., in the form of a message (Step 110). The controller equipment 6 detects an error in the charging session (Step 115). In some embodiments, this error is fatal and causes termination of the charging session (Step 120). After detection of the error, the controller equipment 6 performs the diagnostic process described above (Step 125). Through this diagnostic process, the controller equipment 6 diagnoses that the error was caused by non-conformance of the communication received in Step 110 to the standard 14. The controller equipment 6 furthermore determines the criticality of the non-conformance and/or a fix for the non-conformance.

In some embodiments, the controller equipment 6 provides the results of this diagnostic process to the user 20 or control unit 21 via the communication interface 18 (Step 130). The results inform the user 20 or control unit 21 that the error was caused by non-conformance of the communication received in Step 110. The results also inform the user 20 or control unit 21 about the criticality of and/or the fix for the non-conformance. The controller equipment 6 also prompts the user 20 or control unit 21 for instructions on how to handle the non-conformance in view of the results of the diagnostic process. The controller equipment 6 in these embodiments receives in response the requested instructions (Step 135).

Having completed the diagnostic process, the controller equipment 6 dynamically adapts the programmable logic 8L of the EVCC 8 to handle the non-conformance (Step 140). In embodiments where the user 20 or control unit 21 is consulted for instructions on how to do so, the controller equipment 6 adapts the programmable logic 8L according to those instructions.

Later on, the EV 2 and the EVSE 4 subsequently begin another charging session (Step 145). Again the EV 2 receives communication (Step 150) from the EVSE 4 as a part of this subsequent charging session. This received communication may suffer from the same sort of non-conformance with the standard 14 as the last time. Now, though, the controller equipment 6 has been adapted to accommodate for or otherwise handle this non-conformance. As shown in FIG. 3 in this regard, the EVCC 8 handles the non-conformance of the received communication to the standard 14 according to its programmable logic 8L. This may involve, for instance, modifying the received communication according to the programmable logic 8L, e.g., so that the communication as modified conforms to the standard 14. In some embodiments, then, rather than the communication causing an error that would terminate the subsequent charging session, the subsequent charging session may continue on without causing an error. In other embodiments, the EVCC 8 handles the non-conformance by ignoring certain non-conformance of communication to the standard. In this case, then, rather than the non-conformance causing an error that would terminate the subsequent charging session, the subsequent charging session may continue on despite the error.

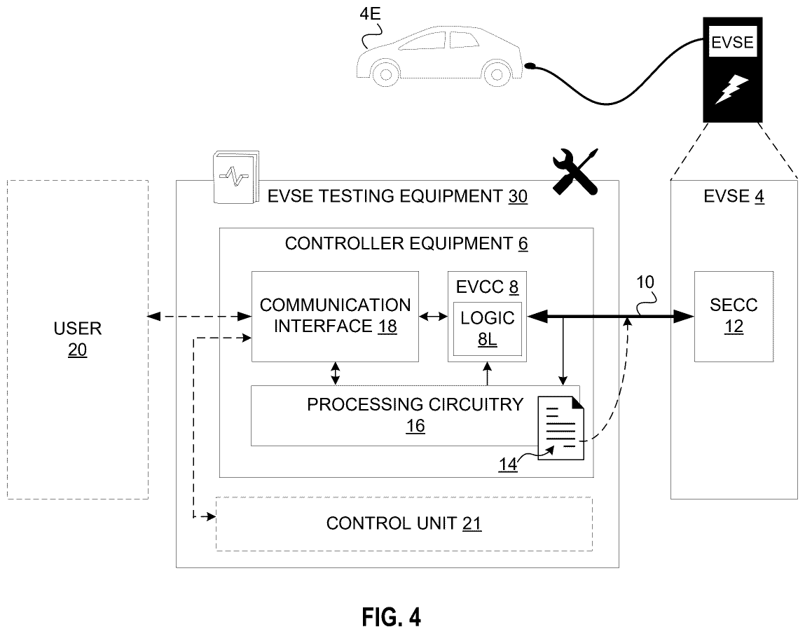

FIG. 2 presents the controller equipment 6 as being incorporated into an EV 2 itself. FIG. 4 by contrast presents the controller equipment 6 as being incorporated into an EVSE tester 30. The EVSE tester 30 emulates an EV 4E in order to test the EVSE 4, e.g., in the field. The controller equipment 6 as part of the EVSE tester 30 nonetheless operates as described above when part of an EV, but just with an emulated EV and an emulated charging session. When incorporated in such an EVSE tester 30, embodiments herein may advantageously reduce the specialization and/or training needed to test and troubleshoot the EVSE 4 for interoperability. Testing of the EVSE 4 may be full-power testing or be limited to control and/or communication testing.

Note that in some embodiments the results of the diagnostic process and/or the instructions on how to handle non-conformance with the standard are shared with the manufacturer of the EVSE 4, e.g., to ensure future firmware updates include fixes for the non-conformance, so that EVs/testers without the controller equipment 6 can also benefit from the results.

Consider now some embodiments herein where the controller equipment 6 in FIGS. 2 and 4 is embodied or described as a so-called Interoperability Debugging Electric Vehicle Automated Logic (IDEAL) controller 6. In some embodiments, this IDEAL controller 6 drastically reduces the time it takes to conduct and debug interoperability testing. In some embodiments, the IDEAL controller 6 allows for a user 20 to access all communication messages transferred to and from EV chargers as part of communication 10, with the added functionality of dynamically detecting and adapting to specific discrepancies proposed by the charger 4 undergoing testing. The increased backend capabilities may allow for the user 20 to manipulate the controller logic 8L to log, flag, and/or adhere to abnormalities amongst different existing EV charging solutions. Some embodiments support electric vehicle standards 14 such as ISO 15118-2 and DINSPEC 70121, while having expansion capabilities to implement future standards 14 such as ISO 15118-20 and bidirectional charging support. The IDEAL controller 6 in some embodiments will allow the charging process to proceed for any non-critical errors in the communications 10 and significantly improve debugging efficiency for conformance testing. Some embodiments may accordingly result in increased interoperability by allowing the IDEAL controller 6 to adjust in the field and reduce the need for time consuming troubleshooting in the field as well as instances of reported interoperability issues with EV drivers.

Some embodiments herein offer one or more of the following advantages. One advantage is self-diagnostics and automated debugging. Immediately after conducting a test with an EVSE 4 that fails a charging sequence, the IDEAL controller 6 in some embodiments will run through a self-diagnostic process which would lead to one or more of the following actions: (A) Identify exactly what parameters resulted in the failure of the test scenario; (B) Identify what the correct values the parameters must be to bypass the fault detected; (C) Identify the criticality of the error to suggest how to proceed; and (D) Present one or more of the following actions: (i) offer to change the parameters to the identified correct values temporarily (for the next test); (ii) offer to change the parameters to the identified correct values permanently; or (iii) terminate testing. The results of the self-diagnostic process may thereby indicate the criticality of the error as well as the suggested fix for the error, e.g., in terms of what values the parameters must be changed to in order to fix the error. This contrasts with existing controllers that are very limited with how and why faults occurs, and in any event leave the onus of finding and fixing a fault to the user.

Another advantage is backend flexibility. The IDEAL controller 6 in some embodiments allows the user 20 access to edit and make changes to the code 8L of the EVCC 8. This may promote transparency for debugging and development purposes. The IDEAL controller 6 may thereby have flexible controller logic that provides flexibility to adjust its code in the field, without needing expert technicians to debug the process.

A further advance is limitless charger compatibility. Some embodiments can adapt to specific requirements chargers 4 may have.

Still another advantage is flexibility to implement future standards. Some embodiments for example support ISO 15118-2 and DINSPEC 70121, while being expandable to include ISO 15118-20 and bidirectional charging support.

In some embodiments, then, interoperability issues between an EV charger 4 and the IDEAL controller 6 can be adjusted in the field (e.g., in a couple of minutes), without access to specialized testing/diagnostic equipment and needing highly trained technicians. In addition to this, there is an option in some embodiments to expand support for complete ISO 15115-4/5 and DIN SPEC 70213 conformance testing,

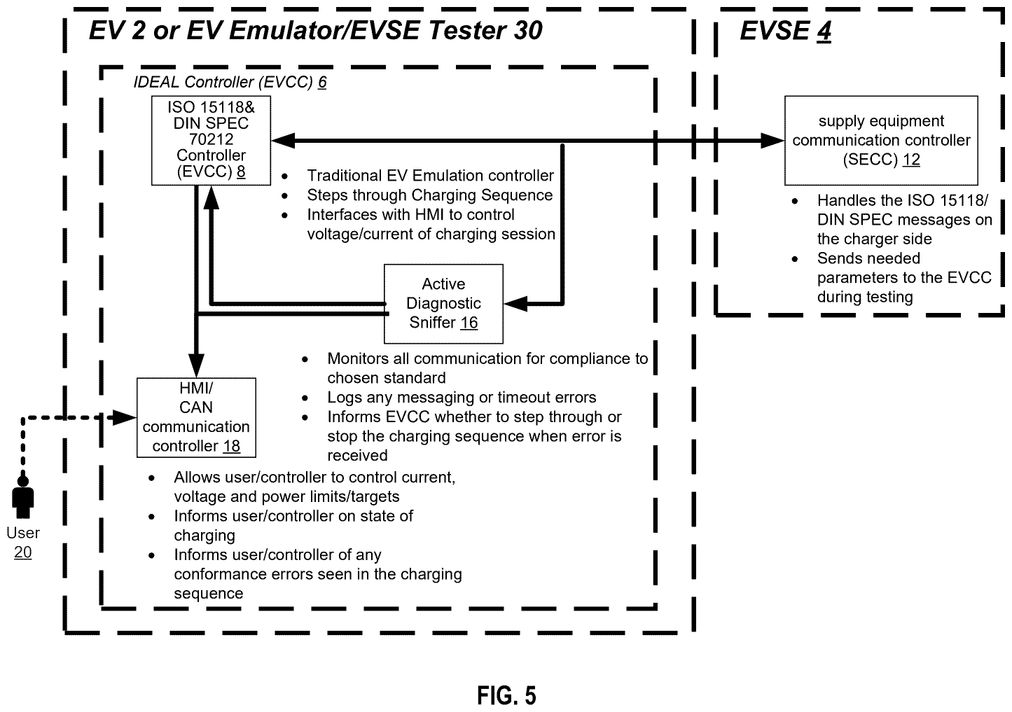

FIG. 5 shows one realization of the IDEAL controller 6, where the processing circuitry 16 in FIGS. 2 and 4 is realized at least in part as a so-called active diagnostic sniffer 16. This active diagnostic sniffer 16 is added to an electric vehicle communication controller (EVCC) 8, e.g., as part of or in association with either an EV 2 or an EV emulator/EVSE tester 30 for testing an EV charger 4 in an emulated charging process. The resulting controller is referred to as an IDEAL controller 6.

In some embodiments, the IDEAL controller 6 is able to analyze EV standard messages (e.g., ISO 15118 and DIN SPEC 70212 messages) and/or create an environment where interoperability issues between the charger 4 and the controller 8 can be adjusted in the field (e.g., in a couple of minutes). The IDEAL controller 6 in some embodiments is able to do so without access to specialized testing/diagnostic equipment and without needing highly trained technicians.

In addition to this, the IDEAL controller 6 in some embodiments is capable of expanding its support to other EV standards, e.g., so as to provide complete ISO 15115-4/5 and DIN SPEC 70213 conformance testing, or to support standards that define full suite conformance testing for ISO 15118 and DIN SPEC 70212.

The IDEAL controller (EVCC) as shown includers an EVCC 8, an active diagnostic sniffer 16, and a Human Machine Interface (HMI) 18 or Controller Area Network (CAN) communication controller 18 for interface with a user 20 or control unit 21. Controller Area Network (CAN) is a serial communication protocol that allows devices to exchange data. It's a message-based protocol that allows Electronic Control Units (ECUs) in vehicles to communicate with each other. HMI stands for Human Machine Interface, which is a technology that allows users to interact with and control systems or devices. Some protocols for Programmable Logic Controller HMI communication include: Ethernet/IP, Modbus, OPC, or Profibus.

The active diagnostic sniffer 16 acts as a solution for interoperability issues seen between an EV 2 and EVSE 4 during a charging sequence. To do this the active diagnostic sniffer 16 both monitors and controls all the communication 10 sent between the EV 2 and EVSE 4. For the monitoring functionality it will look over all the messages sent and received by the EVCC 8 for standards compliance. During this state, it will log sent and/or received messages as well as the time between messages. If any error is detected it will log the error and stop the charging sequence. It will then inform the user 20 or main control unit 21 what the error is and then process the error to find the root cause and severity of the issue. In some embodiments, once this is found it will be communicated to the user 20 or controller 21 and prompt the user or controller 20 to decide whether to proceed past the error. Depending on the error a user 20 may want to only ignore the issue for one charging sequence or ignore the error for all sequential charging sequence.

In some embodiments, this sequence allows for the EVCC 8 to be tailored by the end user 20 so the EVCC 8 can be changed to satisfy any user's needs. To better describe this procedure, two examples are shown below of error where a user 20 would select to always proceed past the error and an error that a user 20 would only want to proceed for one charging session. Both errors have been found through internal testing of a traditional EVCC with public EVSEs.

### EXAMPLE 1

### User Chooses to Always Proceed

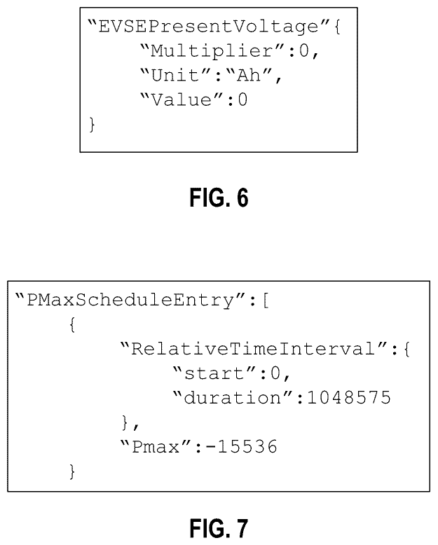

One example error when testing the custom EVCC is that the wrong units are used in the messages being sent between the EV 2 and EVSE 4. FIG. 6 shows a message that was sent by the EVSE 4 under test where, when sending a voltage value, the EVSE 4 gave a unit of ampere-hours.

As this problem is non-impactful to the charging sequence, a user 20 would most likely choose to always proceed past this error. Once this selection is made, the active diagnostic sniffer 16 will change the traditional controller code 8L to only produce a warning when misused units are used for any future charging session.

Notably, an error like this can cause EVCCs to fail the charging sequence leading to interoperability issues between the charger and vehicle. The active diagnostic sniffer 16 advantageously mitigates these issues, where small problems like this can be reported and fixed by EVSE service providers.

### EXAMPLE 2

### User Chooses to Only Proceed for This Session

Another error may occur when public charging schedules a negative max power value in a DIN SPEC 70212 charging session. Scheduling a max power in DIN SPEC 70212 means that the charger 4 is announcing the maximum power it can do for a given amount of time. FIG. 7 shows the charger under test was communicating that the max power was-15536 watts in a unidirectional charging sequence for 1048575 seconds, or for the next 12 days. In the example, this is a messaging error. According to some embodiments, then, a user 20 may choose to ignore this error for the current session, so that the controller 8 is able to complete a full charging test.

In the context of the active diagnostic sniffer 16, a user 20 could choose to only ignore this issue for one test, so the charging sequence can be completed with this charger without having to skip over this error for a different charger. After the user 20 or controller 21 would come to this conclusion, the active diagnostic sniffer 16 would inform the traditional EVCC 8 to only ignore this issue while testing during the next complete charging sequence. This will allow for the EVCC 8 to complete a full charging sequence with this charger 4 while ignoring this issue but inform the user 20 the next time a charger 4 has this error.

Generally, then, some embodiments herein include controller equipment 6 configured to implement the IDEAL controller as described above. The controller equipment 6 may for instance include communication circuitry (e.g., interface 18) and/or processing circuitry 16 to operate as described above.

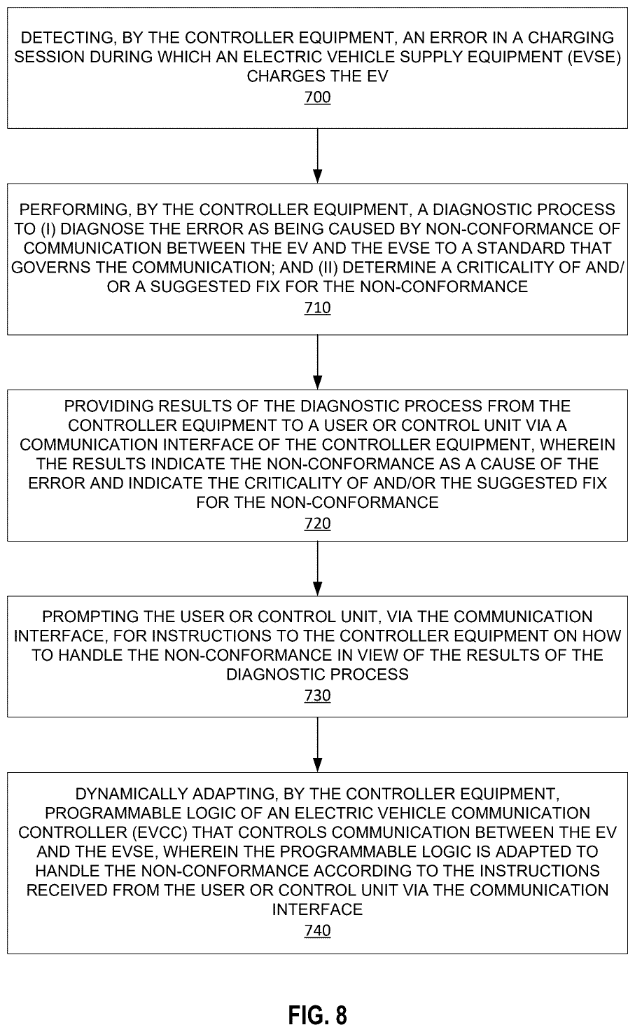

In view of the modifications and variations herein, FIG. 8 depicts a method performed by controller equipment 6 for an electric vehicle (EV) 2 in accordance with particular embodiments. The method includes detecting, by the controller equipment 6, an error in a charging session during which an electric vehicle supply equipment (EVSE) 4 charges the EV 2 (Block 700). The method also comprises performing, by the controller equipment 6, a diagnostic process to (i) diagnose the error as being caused by non-conformance of communication 10 between the EV 2 and the EVSE 4 to a standard 14 that governs the communication 10; and (ii) determine a criticality of and/or a suggested fix for the non-conformance (Block 710). The method also comprises providing results of the diagnostic process from the controller equipment 6 to a user 20 or the control unit 21 via a communication interface 18 of the controller equipment 6. In some embodiments, the results indicate the non-conformance as a cause of the error and indicate the criticality of and/or the suggested fix for the non-conformance (Block 720). The method also comprises prompting the user 20 or control unit 21, via the communication interface 18, for instructions to the controller equipment 6 on how to handle the non-conformance in view of the results of the diagnostic process (Block 730). The method also comprises dynamically adapting, by the controller equipment 6, programmable logic 8L of an electric vehicle communication controller (EVCC) 8 that controls communication between the EV 2 and the EVSE 4. In some embodiments, the programmable logic 8L is adapted to handle the non-conformance according to the instructions received from the user 20 or control unit 21 via the communication interface 18 (Block 740).

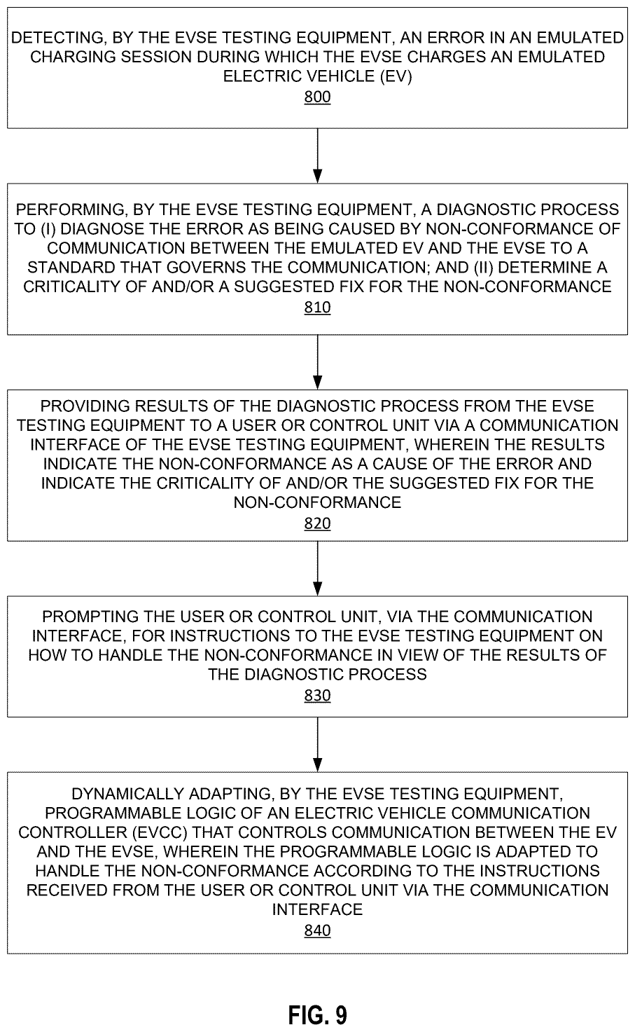

FIG. 9 depicts a method performed by electric vehicle supply equipment (EVSE) testing equipment 30 for testing an EVSE 4 in accordance with other particular embodiments. The method includes detecting, by the EVSE testing equipment 30, an error in an emulated charging session during which the EVSE 4 charges an emulated electric vehicle (EV) 4E (Block 800). The method also comprises performing, by the EVSE testing equipment 30, a diagnostic process to (i) diagnose the error as being caused by non-conformance of communication 10 between the emulated EV 4E and the EVSE 4 to a standard 14 that governs the communication 10; and (ii) determine a criticality of and/or a suggested fix for the non-conformance (Block 810). The method also comprises providing results of the diagnostic process from the EVSE testing equipment 30 to a user 20 or control unit 21 via a communication interface 18 of the EVSE testing equipment 30. In some embodiments, the results indicate the non-conformance as a cause of the error and indicate the criticality of and/or the suggested fix for the non-conformance (Block 820). The method also comprises prompting the user 20 or control uni 21, via the communication interface 18, for instructions to the EVSE testing equipment 30 on how to handle the non-conformance in view of the results of the diagnostic process (Block 830). The method also comprises dynamically adapting, by the EVSE testing equipment 30, programmable logic 8L of an electric vehicle communication controller (EVCC) 8 that controls communication 10 between the EV 2 and the EVSE 4. In some embodiments, the programmable logic 8L is adapted to handle the non-conformance according to the instructions received from the user 20 or control unit 21 via the communication interface 18 (Block 840).

Those skilled in the art will also appreciate that embodiments herein further include corresponding computer programs.

A computer program comprises instructions which, when executed on at least one processor of controller equipment 6, cause the controller equipment 6 to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of controller equipment, cause the controller equipment to perform as described above.

Embodiments further include a computer program product comprising program code portions for performing the steps of any of the embodiments herein when the computer program product is executed by controller equipment. This computer program product may be stored on a computer readable recording medium.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the controller equipment, but are enjoyed by the computing device as a whole.

What is claimed is:

1. Controller equipment for an electric vehicle (EV), the controller equipment comprising:
an electric vehicle communication controller (EVCC) configured with programmable logic that controls communication between the EV and an electric vehicle supply equipment (EVSE);
a communication interface to a user or to a control unit; and
processing circuity communicatively coupled to the EVCC and to the communication interface, wherein the processing circuitry is configured to:
detect an error in a charging session during which the EVSE charges the EV;
perform a diagnostic process to (i) diagnose the error as being caused by non-conformance of communication between the EV and the EVSE to a standard that governs the communication; and (ii) determine a criticality of and/or a suggested fix for the non-conformance;
provide results of the diagnostic process to the user or the control unit via the communication interface, wherein the results indicate the non-conformance as a cause of the error and indicate the criticality of and/or the suggested fix for the non-conformance;
prompt the user or control unit, via the communication interface, for instructions on how to handle the non-conformance in view of the results of the diagnostic process; and
dynamically adapt the programmable logic of the EVCC to handle the non-conformance according to the instructions received from the user or control unit via the communication interface.

2. The controller equipment of claim 1, wherein the processing circuitry is configured to determine the suggested fix for the non-conformance, and wherein the results of the diagnostic process indicate the suggested fix.

3. The controller equipment of claim 2, wherein the instructions instruct the controller equipment to handle the non-conformance by implementing the suggested fix.

4. The controller equipment of claim 1, wherein the processing circuitry is configured to prompt the user or control unit for instructions on how to handle the non-conformance:
temporarily for a limited number of subsequent charging sessions with the EVSE; or
permanently for all subsequent charging sessions with the EVSE.

5. The controller equipment of claim 1, wherein the communication between the EV and the EVSE includes communication of a message from the EVSE to the EV, and wherein the non-conformance is non-conformance of a value of a parameter in the message to a standard that governs what one or more values the parameter is allowed to have.

6. The controller equipment of claim 5, wherein the message is a message of a certain type, and wherein the suggested fix is to change the value of the parameter in messages of the certain type to have one of the one or more values the parameter is allowed to have according to the standard.

7. The controller equipment of claim 6, wherein the processing circuitry is configured to dynamically adapt the programmable logic of the EVCC to, when a message of the certain type is received from the EVSE in a subsequent charging session, change the value of the parameter in the message of the certain type to have one of the one or more values the parameter is allowed to have according to the standard.

8. The controller equipment of claim 5, wherein the message is a message of a certain type, and wherein the processing circuitry is configured to dynamically adapt the programmable logic of the EVCC to, when the message of the certain type is received from the EVSE in a subsequent charging session:
consider non-conformance of the value of the parameter in the message to the standard as a non-critical error rather than as a critical error; and/or
produce a warning about the non-conformance rather than terminating the subsequent charging session.

9. The controller equipment of claim 1, wherein the processing circuitry is configured to determine the non-conformance is non-critical to the charging session, wherein the results of the diagnostic process indicate the non-conformance as being non-critical to charging sessions, and wherein the instructions instruct the controller equipment to handle the non-conformance by considering the non-conformance to be a non-critical error, by ignoring the non-conformance in a subsequent charging session, and/or by producing a warning about the non-conformance but proceeding with the subsequent charging session despite the non-conformance.

10. The controller equipment of claim 1, wherein the standard is ISO 15118 or DINSPEC 70121.

11. The controller equipment of claim 1, wherein the processing circuitry is configured to dynamically adapt the programmable logic of the EVCC to handle the non-conformance in a subsequent charging session, and wherein the EVCC is configured to:
receive, from the EVSE in a subsequent charging session, communication that suffers from the same non-conformance to the standard; and
handle the received communication according to the programmable logic of the EVCC, by:
ignoring the non-conformance of the received communication to the standard and letting the subsequent charging session continue despite the non-conformance; and/or
producing a warning about the non-conformance rather than terminating the subsequent charging session because of the non-conformance.

12. An electric vehicle (EV) comprising the controller equipment of claim 1.

13. EVSE testing equipment for testing an electric vehicle supply equipment (EVSE), the EVSE testing equipment comprising:
an electric vehicle communication controller (EVCC) configured with programmable logic that controls communication between an emulated electric vehicle (EV) and the EVSE;
a communication interface to a user or to a control unit; and
processing circuity communicatively coupled to the EVCC and to the communication interface, wherein the processing circuitry is configured to:
detect an error in an emulated charging session between the EVSE and the emulated EV;
perform a diagnostic process to (i) diagnose the error as being caused by non-conformance of communication between the emulated EV and the EVSE to a standard that governs the communication; and (ii) determine a criticality of and/or a suggested fix for the non-conformance;
provide results of the diagnostic process to the user or the control unit via the communication interface, wherein the results indicate the non-conformance as a cause of the error and indicate the criticality of and/or the suggested fix for the non-conformance;
prompt the user or the control unit, via the communication interface, for instructions on how to handle the non-conformance in view of the results of the diagnostic process; and
dynamically adapt the programmable logic of the EVCC to handle the non-conformance according to the instructions received from the user or control unit via the communication interface.

14. The EVSE testing equipment of claim 13, wherein the processing circuitry is configured to determine the suggested fix for the non-conformance, and wherein the results of the diagnostic process indicate the suggested fix.

15. The EVSE testing equipment of claim 14, wherein the instructions instruct the controller equipment to handle the non-conformance by implementing the suggested fix.

16. The EVSE testing equipment of claim 13, wherein the processing circuitry is configured to prompt the user or the control unit for instructions on how to handle the non-conformance:
temporarily for a limited number of subsequent charging sessions with the EVSE; or
permanently for all subsequent charging sessions with the EVSE.

17. The EVSE testing equipment of claim 13, wherein the communication between the EV and the EVSE includes communication of a message from the EVSE to the emulated EV, and wherein the non-conformance is non-conformance of a value of a parameter in the message to a standard that governs what one or more values the parameter is allowed to have.

18. The EVSE testing equipment of claim 17, wherein the message is a message of a certain type, and wherein the suggested fix is to change the value of the parameter in messages of the certain type to have one of the one or more values the parameter is allowed to have according to the standard.

19. The EVSE testing equipment of claim 18, wherein the processing circuitry is configured to dynamically adapt the programmable logic of the EVCC to, when a message of the certain type is received from the EVSE in a subsequent charging session, change the value of the parameter in the message of the certain type to have one of the one or more values the parameter is allowed to have according to the standard.

20. The EVSE testing equipment of claim 17, wherein the message is a message of a certain type, and wherein the processing circuitry is configured to dynamically adapt the programmable logic of the EVCC to, when the message of the certain type is received from the EVSE in a subsequent charging session:
consider non-conformance of the value of the parameter in the message to the standard as a non-critical error rather than as a critical error; and/or
produce a warning about the non-conformance rather than terminating the subsequent charging session.

21. The EVSE testing equipment of claim 13, wherein the processing circuitry is configured to determine the non-conformance is non-critical to the charging session, wherein the results of the diagnostic process indicate the non-conformance as being non-critical to charging sessions, and wherein the instructions instruct the controller equipment to handle the non-conformance by considering the non-conformance to be a non-critical error, by ignoring the non-conformance in a subsequent charging session and/or by producing a warning about the non-conformance but proceeding with the subsequent charging session despite the non-conformance.

22. The EVSE testing equipment of claim 13, wherein the standard is ISO 15118 or DINSPEC 70121.

23. A method performed by controller equipment for an electric vehicle (EV), the method comprising:
detecting, by the controller equipment, an error in a charging session during which an electric vehicle supply equipment (EVSE) charges the EV;
perform, by the controller equipment, a diagnostic process to (i) diagnose the error as being caused by non-conformance of communication between the EV and the EVSE to a standard that governs the communication; and (ii) determine a criticality of and/or a suggested fix for the non-conformance;
provide results of the diagnostic process from the controller equipment to a user or control unit via a communication interface of the controller equipment, wherein the results indicate the non-conformance as a cause of the error and indicate the criticality of and/or the suggested fix for the non-conformance;
prompt the user or the control unit, via the communication interface, for instructions to the controller equipment on how to handle the non-conformance in view of the results of the diagnostic process; and
dynamically adapt, by the controller equipment, programmable logic of an electric vehicle communication controller (EVCC) that controls communication between the EV and the EVSE, wherein the programmable logic is adapted to handle the non-conformance according to the instructions received from the user or the control unit via the communication interface.

24. A method performed by EVSE testing equipment for testing an electric vehicle supply equipment (EVSE), the method comprising:
detecting, by the EVSE testing equipment, an error in an emulated charging session during which the EVSE charges an emulated electric vehicle (EV);
perform, by the EVSE testing equipment, a diagnostic process to (i) diagnose the error as being caused by non-conformance of communication between the emulated EV and the EVSE to a standard that governs the communication; and (ii) determine a criticality of and/or a suggested fix for the non-conformance;
provide results of the diagnostic process from the EVSE testing equipment to a user or a control unit via a communication interface of the EVSE testing equipment, wherein the results indicate the non-conformance as a cause of the error and indicate the criticality of and/or the suggested fix for the non-conformance;
prompt the user or control unit, via the communication interface, for instructions to the EVSE testing equipment on how to handle the non-conformance in view of the results of the diagnostic process; and
dynamically adapt, by the EVSE testing equipment, programmable logic of an electric vehicle communication controller (EVCC) that controls communication between the EV and the EVSE, wherein the programmable logic is adapted to handle the non-conformance according to the instructions received from the user or control unit via the communication interface.
